(19) United States
(12) Patent Application Publication
(10) Pub. No.: US 2024/0364391 A1
(43) Pub. Date: Oct. 31, 2024

(54) MU-MIMO Transmission With Mixed Bandwidths And Unequal Modulations In Wireless Communications

(71) Applicant: MediaTek Inc., Hsinchu City (TW)

(72) Inventors: Shengquan Hu, San Jose, CA (US); Jianhan Liu, San Jose, CA (US); Thomas Edward Pare, JR., San Jose, CA (US)

(21) Appl. No.: 18/646,863

(22) Filed: Apr. 26, 2024

Related U.S. Application Data
(60) Provisional application No. 63/498,560, filed on Apr. 27, 2023.

(51) Int. Cl. H04B 7/0452; H04L 27/00

(52) U.S. Cl. CPC H04B 7/0452; H04L 27/0008

(57) ABSTRACT

Techniques pertaining to multi-user multiple-input-multiple-output (MU-MIMO) transmission with mixed bandwidths and unequal modulation (UEQM) in wireless communications are described. An apparatus allocates a plurality of resource units (RUs) to a plurality of stations (STAs). The apparatus then performs mixed-bandwidth MU-MIMO communications with the plurality of STAs using the plurality of RUs.

### CROSS REFERENCE TO RELATED PATENT APPLICATION(S)

The present disclosure is part of a non-provisional patent application claiming the priority benefit of U.S. Provisional Patent Application No. 63/498,560, filed 27 Apr. 2023, the content of which herein being incorporated by reference in its entirety.

### TECHNICAL FIELD

The present disclosure is generally related to wireless communications and, more particularly, to multi-user multiple-input-multiple-output (MU-MIMO) transmission with mixed bandwidths and unequal modulation (UEQM) in wireless communications.

### BACKGROUND

Unless otherwise indicated herein, approaches described in this section are not prior art to the claims listed below and are not admitted as prior art by inclusion in this section.

In wireless communications such as Wi-Fi (or WiFi) in accordance with the Institute of Electrical and Electronics Engineers (IEEE) 802.11 standards, increasing throughput and using spectrum more efficiently are key objectives for next-generation WLANs such as Wi-Fi 8. In a heterogeneous network environment where devices or stations (STAs) of different capabilities are deployed, each STA may have a different capability of supporting a respective size of channel bandwidth than one or more other STAs. For example, a first STA (STA1) may support a wider bandwidth such as 160 MHz while a second STA (STA2) may have a limited capability and thus may support up to 80 MHz. In case that an access point (AP) schedules both STA1 and STA2 to perform MU-MIMO transmission only on an 80 MHz bandwidth, then another 80 MHz spectrum of the 160 MHz-capable STA1 would be wasted. Therefore, there is a need for a solution of MU-MIMO transmission with mixed bandwidths and UEQM in wireless communications.

### SUMMARY

The following summary is illustrative only and is not intended to be limiting in any way. That is, the following summary is provided to introduce concepts, highlights, benefits and advantages of the novel and non-obvious techniques described herein. Select implementations are further described below in the detailed description. Thus, the following summary is not intended to identify essential features of the claimed subject matter, nor is it intended for use in determining the scope of the claimed subject matter.

An objective of the present disclosure is to provide schemes, concepts, designs, techniques, methods and apparatuses pertaining to MU-MIMO transmission with mixed bandwidths and UEQM in wireless communications. Under various proposed schemes in accordance with the present disclosure, mixed-distribution bandwidth operations may be enabled with dRU resource assignment and scheduling described herein. It is believed that implementations of one or more of the proposed schemes may address or otherwise alleviate the aforementioned issue(s).

In one aspect, a method may involve a processor of an apparatus allocating a plurality of resource units (RUs) to a plurality of STAs. The method may also involve the processor performing mixed-bandwidth MU-MIMO communications with the plurality of STAs using the plurality of RUs.

In another aspect, a method may involve a processor of an apparatus generating one or more RUs. The method may also involve the processor performing mixed-bandwidth MU-MIMO communications with the one or more RUs.

In another aspect, an apparatus may include a transceiver configured to communicate wirelessly and a processor coupled to the transceiver. The processor may allocate a plurality of RUs to a plurality of STAs. The processor may also perform mixed-bandwidth MU-MIMO communications with the plurality of STAs using the plurality of RUs.

It is noteworthy that, although description provided herein may be in the context of certain radio access technologies, networks and network topologies such as, Wi-Fi/WLAN, the proposed concepts, schemes and any variation(s)/derivative(s) thereof may be implemented in, for and by other types of radio access technologies, networks and network topologies such as, for example and without limitation, Bluetooth, ZigBee, 5^{th} Generation (5G)/New Radio (NR), Long-Term Evolution (LTE), LTE-Advanced, LTE-Advanced Pro, Internet-of-Things (IoT), Industrial IoT (IIoT) and narrowband IoT (NB-IoT). Thus, the scope of the present disclosure is not limited to the examples described herein.

### BRIEF DESCRIPTION OF THE DRAWINGS

The accompanying drawings are included to provide a further understanding of the disclosure and are incorporated in and constitute a part of the present disclosure. The drawings illustrate implementations of the disclosure and, together with the description, serve to explain the principles of the disclosure. It is appreciable that the drawings are not necessarily in scale as some components may be shown to be out of proportion than the size in actual implementation to clearly illustrate the concept of the present disclosure.

FIG. 1 is a diagram of an example network environment in which various solutions and schemes in accordance with the present disclosure may be implemented.

FIG. 2 is a diagram of an example scenario of various operation modes.

FIG. 3 is a diagram of an example scenario under a proposed scheme in accordance with the present disclosure.

FIG. 4 is a diagram of an example scenario under a proposed scheme in accordance with the present disclosure.

FIG. 5 is a diagram of an example scenario under a proposed scheme in accordance with the present disclosure.

FIG. 6 is a diagram of an example scenario under a proposed scheme in accordance with the present disclosure.

FIG. 7 is a diagram of an example scenario under a proposed scheme in accordance with the present disclosure.

FIG. 8 is a diagram of an example scenario under a proposed scheme in accordance with the present disclosure.

FIG. 9 is a diagram of an example scenario under a proposed scheme in accordance with the present disclosure.

FIG. 10 is a diagram of an example scenario under a proposed scheme in accordance with the present disclosure.

FIG. 11 is a diagram of an example scenario under a proposed scheme in accordance with the present disclosure.

FIG. 12 is a diagram of an example scenario under a proposed scheme in accordance with the present disclosure.

FIG. 13 is a diagram of an example scenario under a proposed scheme in accordance with the present disclosure.

FIG. 14 is a block diagram of an example communication system in accordance with an implementation of the present disclosure.

FIG. 15 is a flowchart of an example process in accordance with an implementation of the present disclosure.

FIG. 16 is a flowchart of an example process in accordance with an implementation of the present disclosure.

### DETAILED DESCRIPTION OF PREFERRED EMBODIMENTS

Detailed embodiments and implementations of the claimed subject matters are disclosed herein. However, it shall be understood that the disclosed embodiments and implementations are merely illustrative of the claimed subject matters which may be embodied in various forms. The present disclosure may, however, be embodied in many different forms and should not be construed as limited to the exemplary embodiments and implementations set forth herein. Rather, these exemplary embodiments and implementations are provided so that description of the present disclosure is thorough and complete and will fully convey the scope of the present disclosure to those skilled in the art. In the description below, details of well-known features and techniques may be omitted to avoid unnecessarily obscuring the presented embodiments and implementations.

### Overview

Implementations in accordance with the present disclosure relate to various techniques, methods, schemes and/or solutions pertaining to MU-MIMO transmission with mixed bandwidths and UEQM in wireless communications. According to the present disclosure, a number of possible solutions may be implemented separately or jointly. That is, although these possible solutions may be described below separately, two or more of these possible solutions may be implemented in one combination or another.

It is noteworthy that, in the present disclosure, a regular (non-distributed) RU (RRU or RRU) refers to a RU with tones that are continuous (e.g., adjacent to one another) and not interleaved, interlaced or otherwise distributed. Moreover, a 26-tone regular RU may be interchangeably denoted as RU26 (or RRU26), a 52-tone regular RU may be interchangeably denoted as RU52 (or RRU52), a 106-tone regular RU may be interchangeably denoted as RU106 (or RRU106), a 242-tone regular RU may be interchangeably denoted as RU242 (or RRU242), and so on. Moreover, a 26-tone distributed-tone RU may be interchangeably denoted as dRU26 (or DRU26), a 52-tone distributed-tone RU may be interchangeably denoted as dRU52 (or DRU52), a 106-tone distributed-tone RU may be interchangeably denoted as dRU106 (or DRU106), a 242-tone distributed-tone RU may be interchangeably denoted as dRU242 (or DRU242), and so on. Moreover, an aggregate (26+52)-tone regular multi-RU (MRU) may be interchangeably denoted as MRU78 (or RMRU78), an aggregate (26+106)-tone regular MRU may be interchangeably denoted as MRU132 (or RMRU132), and so on. Furthermore, an aggregate (26+52)-tone distributed-tone MRU (DMRU) may be interchangeably denoted as dMRU132, and so on.

It is also noteworthy that, in the present disclosure, a bandwidth of 20 MHz may be interchangeably denoted as BW20 or BW20M, a bandwidth of 40 MHz may be interchangeably denoted as BW40 or BW40M, a bandwidth of 80 MHz may be interchangeably denoted as BW80 or BW80M, a bandwidth of 160 MHz may be interchangeably denoted as BW160 or BW160M, a bandwidth of 240 MHz may be interchangeably denoted as BW240 or BW240M, a bandwidth of 320 MHz may be interchangeably denoted as BW320 or BW320M, a bandwidth of 480 MHz may be interchangeably denoted as BW480 or BW480M, a bandwidth of 500 MHz may be interchangeably denoted as BW500 or BW500M, a bandwidth of 520 MHz may be interchangeably denoted as BW520 or BW520M, a bandwidth of 540 MHz may be interchangeably denoted as BW540 or BW540M, a bandwidth of 640 MHz may be interchangeably denoted as BW640 or BW640M.

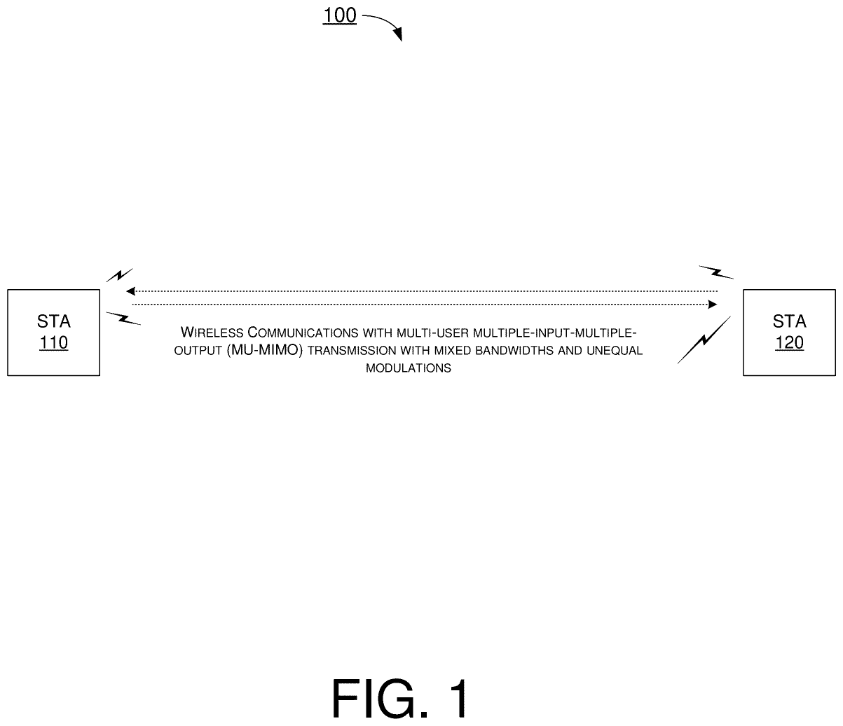

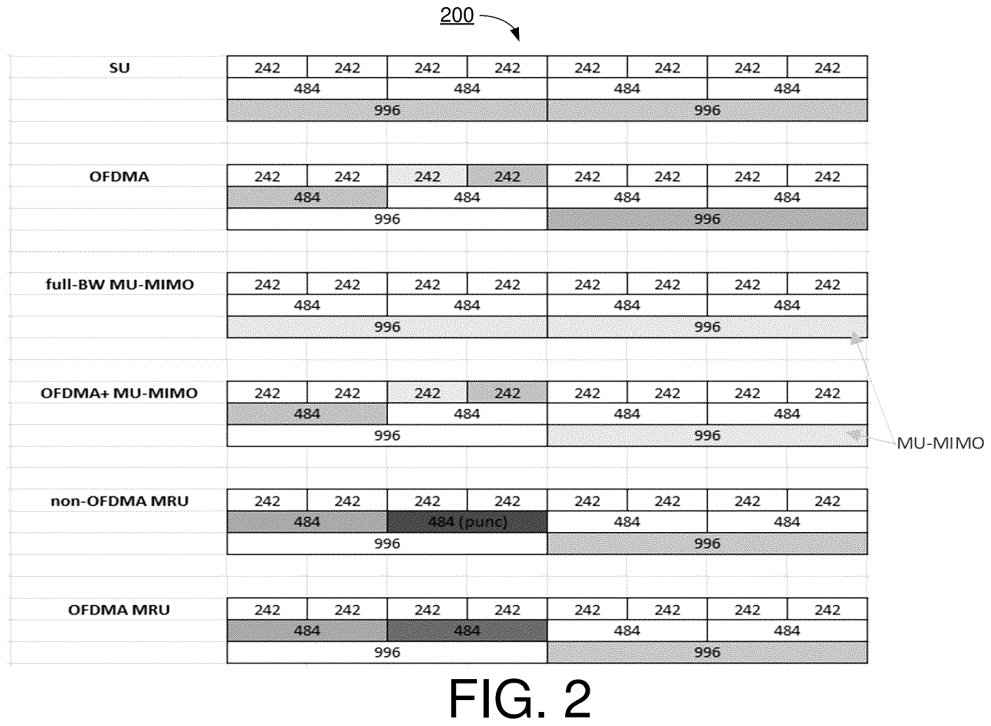

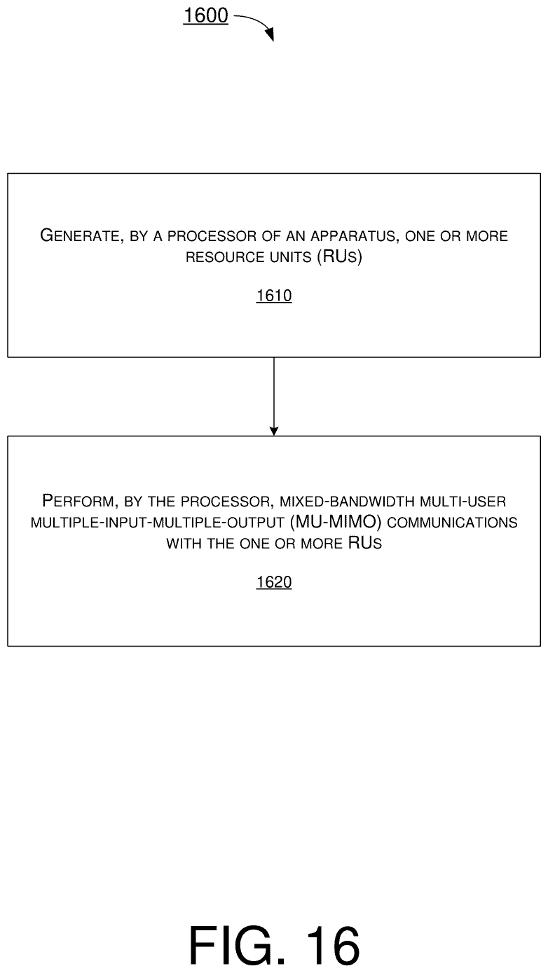

FIG. 1 illustrates an example network environment 100 in which various solutions and schemes in accordance with the present disclosure may be implemented. FIG. 2 FIG. 16 illustrate examples of implementation of various proposed schemes in network environment 100 in accordance with the present disclosure. The following description of various proposed schemes is provided with reference to FIG. 1˜FIG. 16.

Referring to FIG. 1, network environment 100 may involve at least a STA 110 communicating wirelessly with a STA 120. Either of STA 110 and STA 120 may be an access point (AP) STA or, alternatively, either of STA 110 and STA 120 may function as a non-AP STA. In some cases, STA 110 and STA 120 may be associated with a basic service set (BSS) in accordance with one or more IEEE 802.11 standards (e.g., IEEE 802.11 be and future-developed standards). Each of STA 110 and STA 120 may be configured to communicate with each other by utilizing the various proposed schemes of MU-MIMO transmission with mixed bandwidths and UEQM in wireless communications in accordance with various proposed schemes described below. That is, either or both of STA 110 and STA 120 may function as a “user” in the proposed schemes and examples described below. It is noteworthy that, while the various proposed schemes may be individually or separately described below, in actual implementations some or all of the proposed schemes may be utilized or otherwise implemented jointly. Of course, each of the proposed schemes may be utilized or otherwise implemented individually or separately.

FIG. 2 illustrates an example scenario 200 of various operation modes. Referring to FIG. 2, under the IEEE 802.11 be, available operation modes by STAs may include a single-user (SU) mode, an orthogonal frequency-division multiple-access (OFDMAO) mode, a full-bandwidth MU-MIMO mode, an OFDAM+MU-MIMO mode, a non-OFDMA multi-resource unit (MRU) mode, and an OFDMA MRU mode. These operation modes may be utilized with additional techniques and/or variations under various proposed schemes in accordance with the present disclosure, as described below.

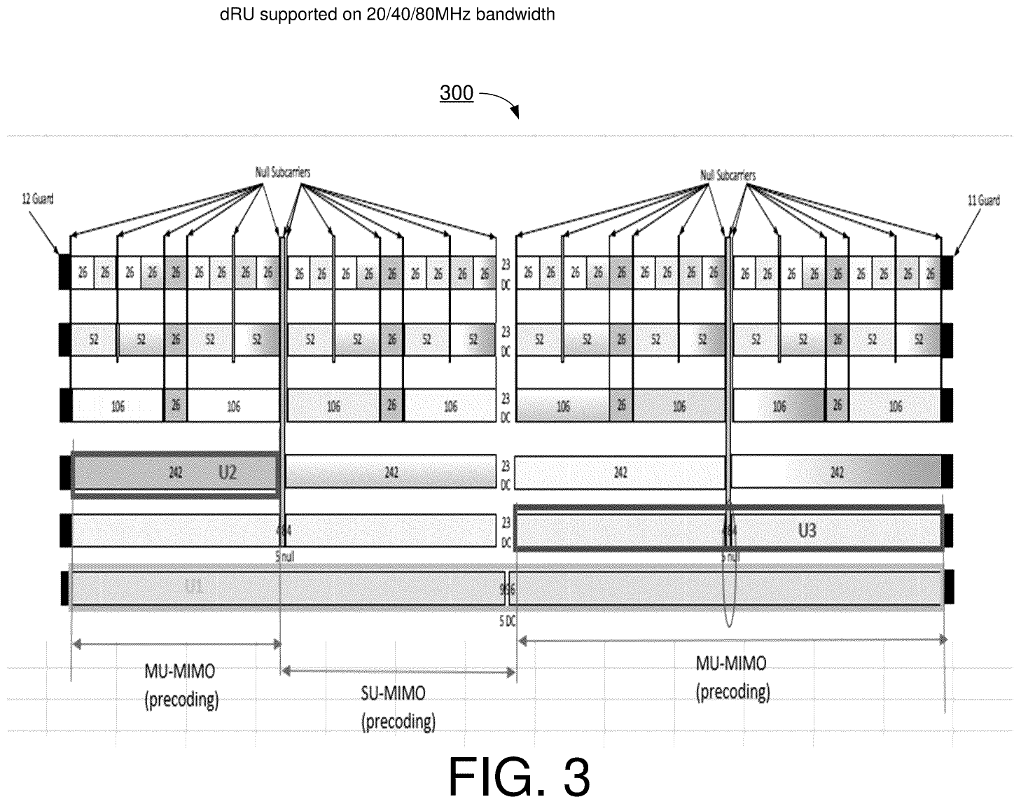

FIG. 3 illustrates an example scenario 300 under a proposed scheme (Proposal-0) in accordance with the present disclosure. Scenario 300 may pertain to a mixed-bandwidth MU-MIMO without limitations. In scenario 300, different users (e.g., STAs) may support different bandwidth (BW) capabilities. Under the proposed scheme, an AP may allocate different MU-MIMO assignments to different users (e.g., including a number of users, a number of spatial streams, and the like, on different frequency segments or frequency subblocks) across different frequency segments/frequency subblocks without limitations, with at least one user (which supports a larger BW such as 160 MHz or greater) operating across multiple MU-MIMO regions.

In the example shown in FIG. 3, a first user (U1) may operate (e.g., communicate such as transmit and/or receive) on a 996-tone RU (RU996), a second user (U2) may operate on a first 242-tone RU (RU242) or a first 484-tone RU (RU484), and a third user (U3) may operate on a second RU484. Under this proposed scheme, there may be five null tones in a given RU484 (but not in a RU996). Precoding matrix design and channel smoothing may be complicated under this proposed scheme. Demodulation control may also be complicated for uplink (UL) transmissions (e.g., partial tones may be SU and other tones may be MU-MIMO). Moreover, signaling under this proposed scheme may be more efficient but may still need more modifications. Also, there may be no need to define new MRU under this proposed scheme.

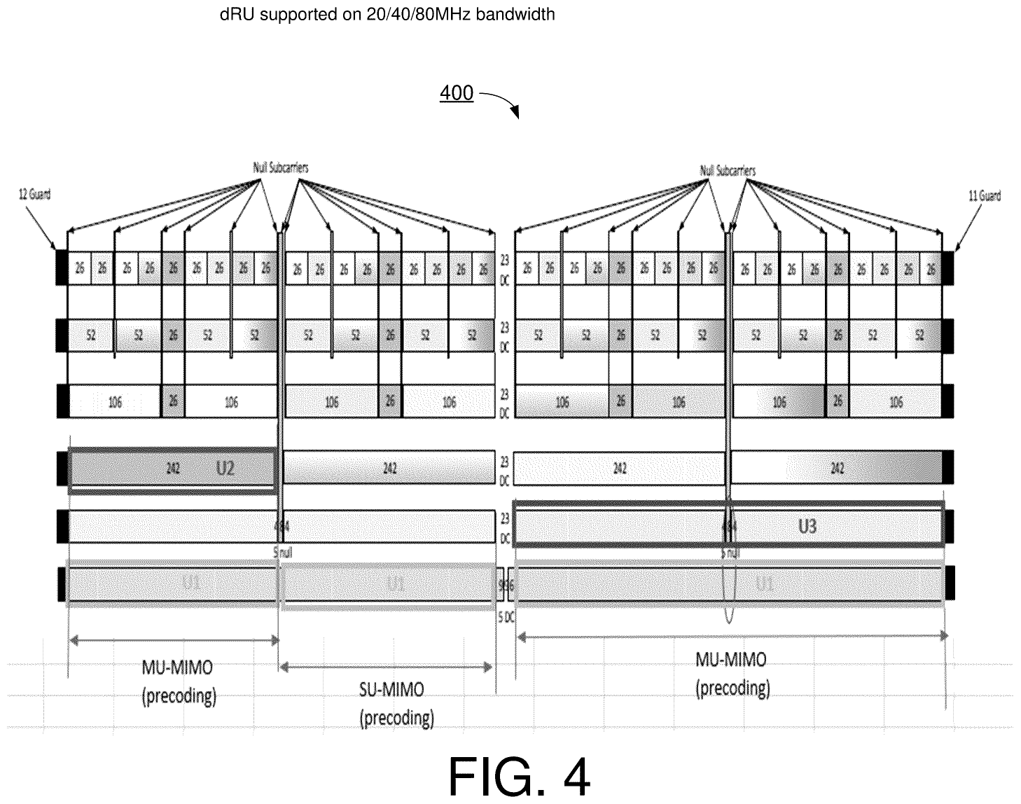

FIG. 4 illustrates an example scenario 400 under a proposed scheme (Proposal-1) in accordance with the present disclosure. Scenario 400 may pertain to a mixed-BW MU-MIMO with resource unit (RU) alignment. In scenario 400, one limitation may be that communications by STAs with mixed-BW MU-MIMO may be RU-aligned. Under the proposed scheme, an AP may allocate different MU-MIMO assignments to different users (e.g., including a number of users, a number of spatial streams, and the like, on different frequency segments or frequency subblocks) across different frequency segments/frequency subblocks with RUs being boundary aligned with one another, with at least one user (which supports a larger BW such as 160 MHz or greater) operating across multiple RU/MRU MU-MIMO regions.

In the example shown in FIG. 4, a first user (U1) may operate (e.g., communicate such as transmit and/or receive) on a RU(242+242+484), a second user (U2) may operate on a RU242, and a third user (U3) may operate on a RU484. Under this proposed scheme, there may be about 4.5% loss in spectral efficiency. There may also be a need to define new MRU for encoding and pre-forward error correction (pre-FEC) padding calculation (e.g., MRU(484+484)), a need for a new RU parser, and a need for new tone mapper parameters (e.g., Dtm) for the new MRU. Under this proposed scheme, signaling may not be efficient, and monitoring of multiple association identifiers (AIDs) per STA may be required. On the other hand, precoding and channel smoothing may be relatively easier compared to the Proposal-0.

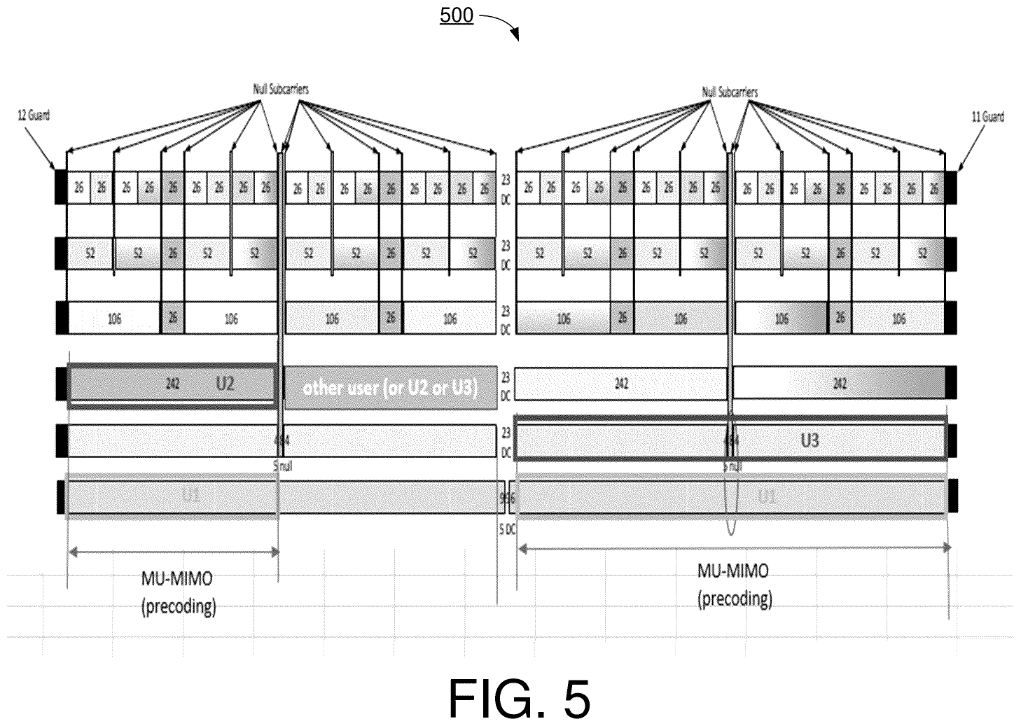

FIG. 5 illustrates an example scenario 500 under a proposed scheme (Proposal-2) in accordance with the present disclosure. Scenario 500 may pertain to a mixed-BW MU-MIMO based on large RU/MRU (e.g., RU242 or larger). In scenario 500, one limitation may be that communications by STAs may involve large RU-based or large MRU-based mixed-BW MU-MIMO.

In the example shown in FIG. 5, a first user (U1) may operate (e.g., communicate such as transmit and/or receive) on an MRU(242+484), a second user (U2) may operate on a RU242 or RU484, and a third user (U3) may operate on another RU484 or another MRU(242+484). Under this proposed scheme, there may be about 4.5% loss in spectral efficiency. There may be no need of new MRU for encoding/pre-FEC padding calculation, no need of new RU parser, and no need of new tone mapper parameters (e.g., Dtm) for new MRU. On the other hand, precoding and channel smoothing may be relatively easier compared to the Proposal-0.

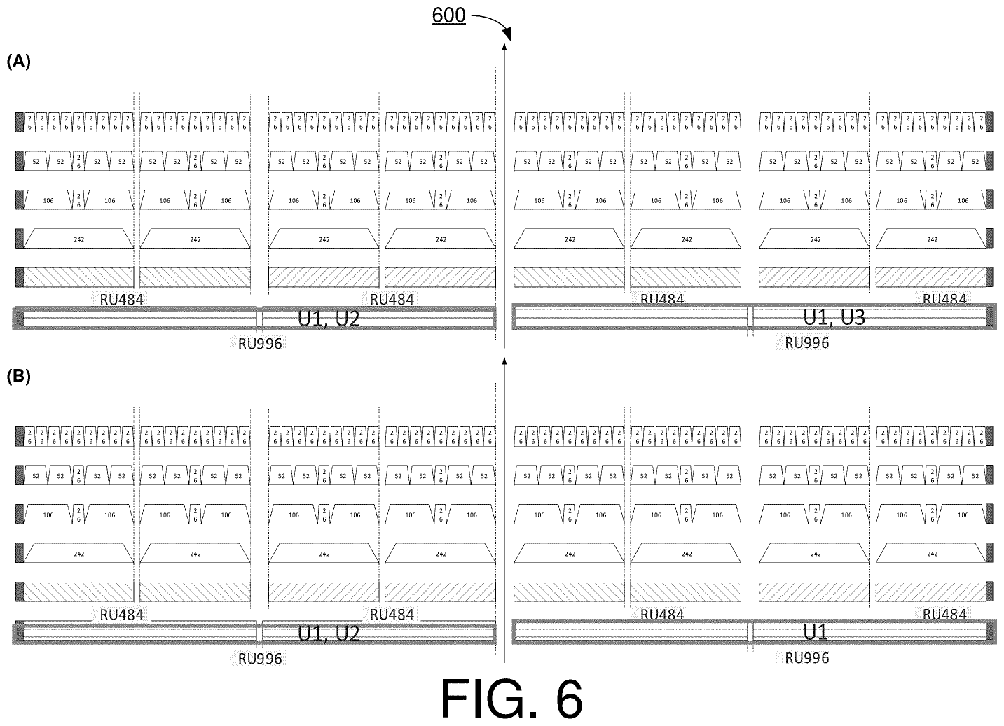

FIG. 6 illustrates an example scenario 600 under a proposed scheme (Proposal-3) in accordance with the present disclosure. Scenario 600 may pertain to a mixed-BW MU-MIMO with RU996 or 80 MHz segment alignment. In scenario 600, one limitation may be that mixed-BW MU-MIMO communications by STAs may need to be RU996 or RU2×996 or RU3×996 or RU4×996 aligned. Under the proposed scheme, an AP may allocate different MU-MIMO assignments to different users (e.g., including a number of users, a number of spatial streams, and the like, on different frequency segments or frequency subblocks) across different 80 MHz frequency segments/frequency subblocks with RU996 boundary aligned, with at least one user (which supports a larger BW such as 160 MHz or greater) operating across multiple 80 MHz frequency segments/frequency subblocks.

In the example shown in part (A) of FIG. 6, a first user (U1) may operate (e.g., communicate such as transmit and/or receive) on an RU(2×996), a second user (U2) may operate on one RU996, and a third user (U3) may operate on the other RU996. In the example shown in part (B) of FIG. 6, U1 may operate on an RU(2×996) and U2 may operate on one of the two RU996s.

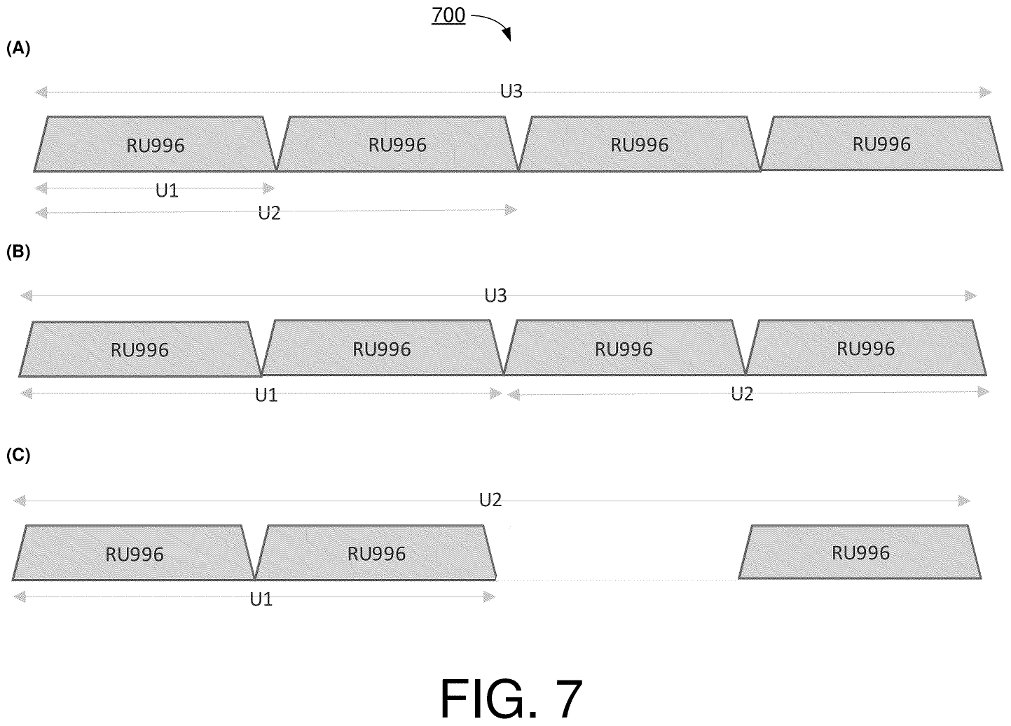

FIG. 7 illustrates an example scenario 700 under Proposal-3. In the example shown in part (A) of FIG. 7, a first user (U1) may operate (e.g., communicate such as transmit and/or receive) on a first RU996, a second user (U2) may operate on a first RU(2×996), and a third user (U3) may operate on an RU(4×996). In the example shown in part (B) of FIG. 7, U1 may operate on a first RU(2×996), U2 may operate on a second RU(2×996), and U3 may operate on an RU(4×996). In the example shown in part (C) of FIG. 7, U1 may operate on a first RU(2×996), and U2 may operate on an RU(3×996) with a third RU996 punctured.

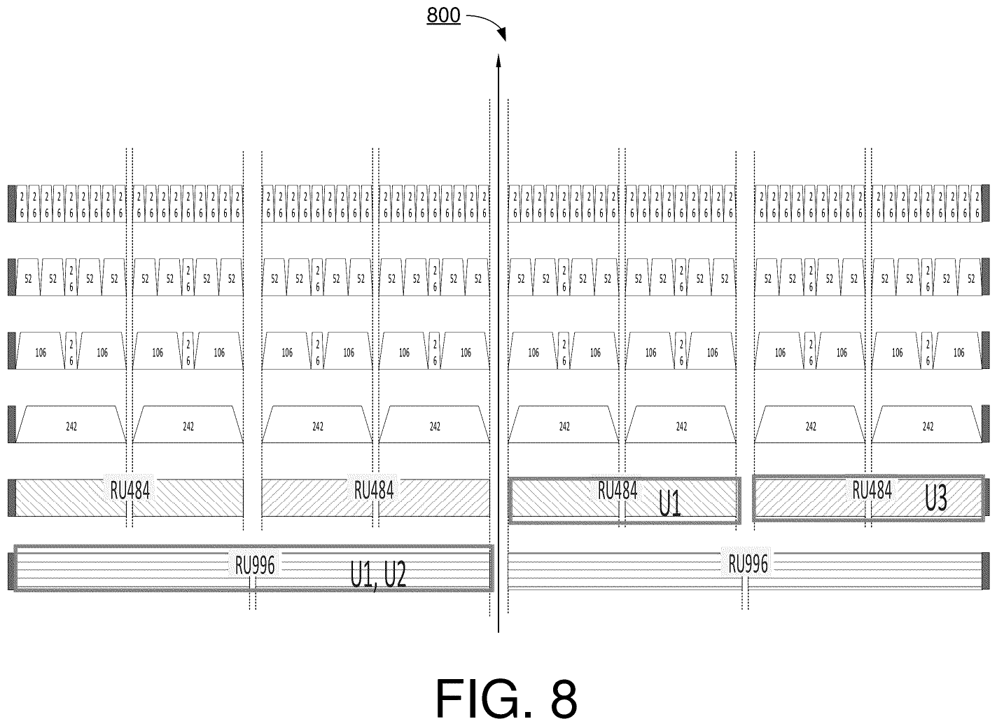

FIG. 8 illustrates an example scenario 800 under a proposed scheme (Proposal-4) in accordance with the present disclosure. Scenario 800 may pertain to a mixed-BW MU-MIMO based on large RU/MRU across an 80 MHz frequency segment/frequency subblock. In scenario 800, one limitation may be that mixed-BW MU-MIMO communications by STAs may need to be RU996 or large RU/MRU aligned. Under the proposed scheme, an AP may allocate different MU-MIMO assignments to different users (e.g., including a number of users, a number of spatial streams, and the like, on different frequency segments or frequency subblocks) across different 80 MHz frequency segments/frequency subblocks with RU484 or large RU/MRU boundary aligned, with at least one user (which supports a larger BW such as 160 MHz or greater) operating across multiple 80 MHz frequency segments/frequency subblocks.

In the example shown in FIG. 8, a first user (U1) may operate (e.g., communicate such as transmit and/or receive) on an RU(484+996), a second user (U2) may operate on one RU996, and a third user (U3) may operate on another RU484.

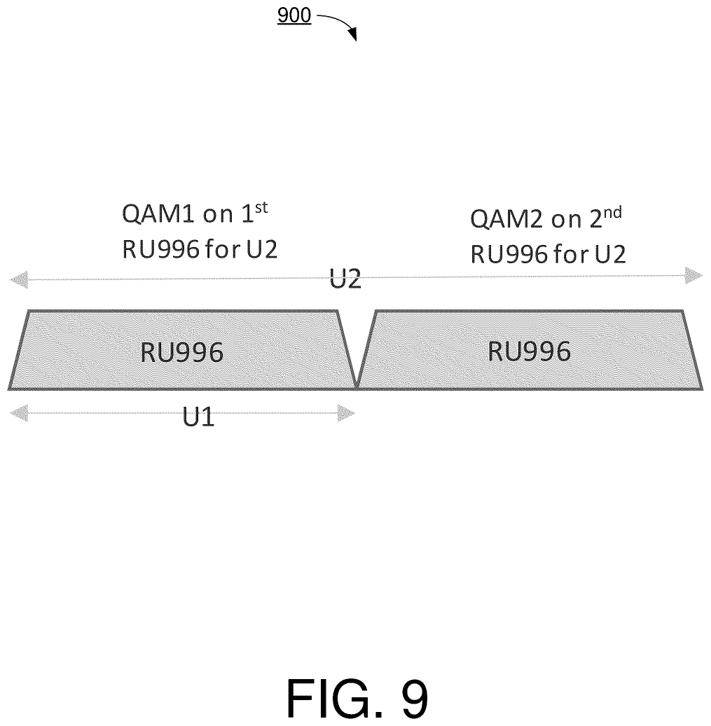

FIG. 9 illustrates an example scenario 900 under a proposed scheme (Proposal-5) in accordance with the present disclosure. Scenario 900 may pertain to UEQM for a mixed-BW MU-MIMO. Under the proposed scheme, for a STA supporting a wider bandwidth, partial frequency segment (e.g., in units of RU996 or 80 MHz) may be shared with other STAs with MU-MIMO transmission, and part of the wireless spectrum may be transmitted with SU-MIMO for this STA. With BW160 as an example, STA1 (for U1) may share a first RU996 with STA2 (for U2) and may transmit with two-user MU-MIMO on a first RU996, while STA2 may additionally transmit on a second RU996 for itself with SU-MIMO.

Under this proposed scheme, in a mixed-BW MU-MIMO situation, UEQM may be used to improve system throughput and link reliability. For instance, in the example shown in FIG. 9, a lower quadrature amplitude modulation (QAM) may be assigned for U2 on the first RU996 (e.g., modulation with QAM1 on the first RU996), and a higher QAM may be assigned for U2 on the second RU996 (e.g., modulation with QAM2 on the second RU996).

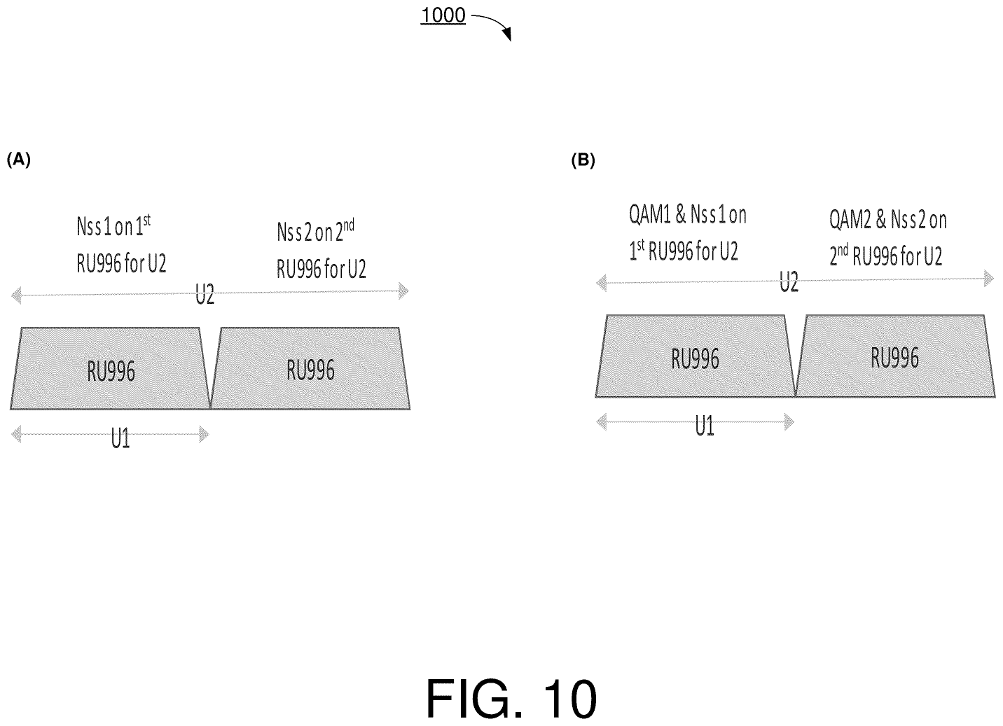

FIG. 10 illustrates an example scenario 1000 under a proposed scheme (Proposal-6) in accordance with the present disclosure. Scenario 1000 may pertain to unequal numbers of spatial streams for a mixed-BW MU-MIMO. Under the proposed scheme, other than unequal modulation assignment for a user of a wider BW in a mixed-BW MU-MIMO operation, unequal numbers of spatial streams may be scheduled for a user on different frequency segments or frequency subblocks. For instance, the number of spatial streams on a MU-MIMO segment may be different from the number of spatial streams on a SU-MIMO segment (or another MU-MIMO segment).

In the example shown in part (A) of FIG. 10, STA1 (for U1) may share a first RU996 with STA2 (for U2) and may transmit with two-user MU-MIMO on a first RU996, while STA2 may additionally transmit on a second RU996 for itself with SU-MIMO. Under the proposed scheme, a first number of spatial streams (Nₛₛ₁) may be assigned for U2 on the first RU996 and a second number of spatial streams (Nₛₛ₂) may be assigned for U2 on the second RU996. In the example shown in part (B) of FIG. 10, UEQM and unequal numbers of spatial streams may be applied at the same time for the mixed-BW MU-MIMO operation. For instance, QAM1 and Nₛₛ₁ may be assigned for U2 on the first RU996, and QAM2 and Nₛₛ₂ may be assigned for U2 on the second RU996.

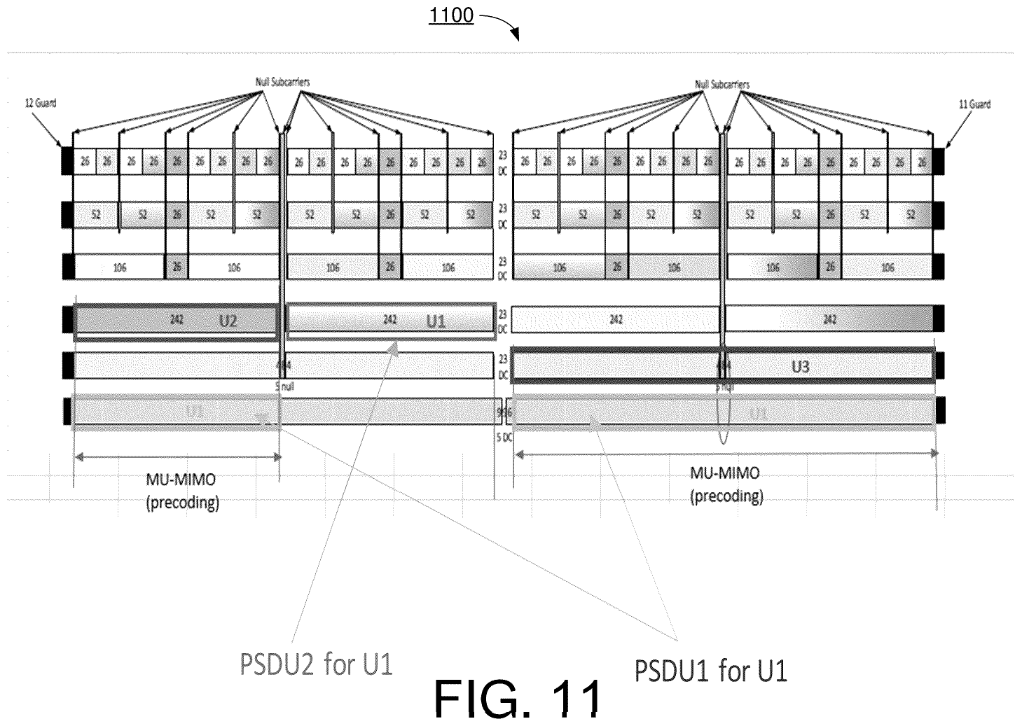

FIG. 11 illustrates an example scenario 1100 under a proposed scheme (Proposal-7) in accordance with the present disclosure. Scenario 1100 may pertain to multi-physical-layer service data unit (multi-PSDU) per user in a mixed-BW MU-MIMO operation. On top of Proposal-0, Proposal-1, Proposal-2, Proposal-3, Proposal-4, Proposal-5 and Proposal-6 described above, up to two PSDUs per user may be supported under this proposed scheme. For instance, on each frequency segment or frequency subblock, either unequal QAM or unequal modulation and coding scheme (MCS) may be applied. For a multi-PSDU case, a separate encoding process may be needed. In the example shown in FIG. 11, with 80 MHz, a first user (U1) may operate with a first PSDU (PSDU1) on an MRU(242+484) and with a second PSDU (PSDU2) on a second RU242, a second user (U2) may operate on a first RU242, and a third user (U3) may operate on another RU484 or another MRU(242+484).

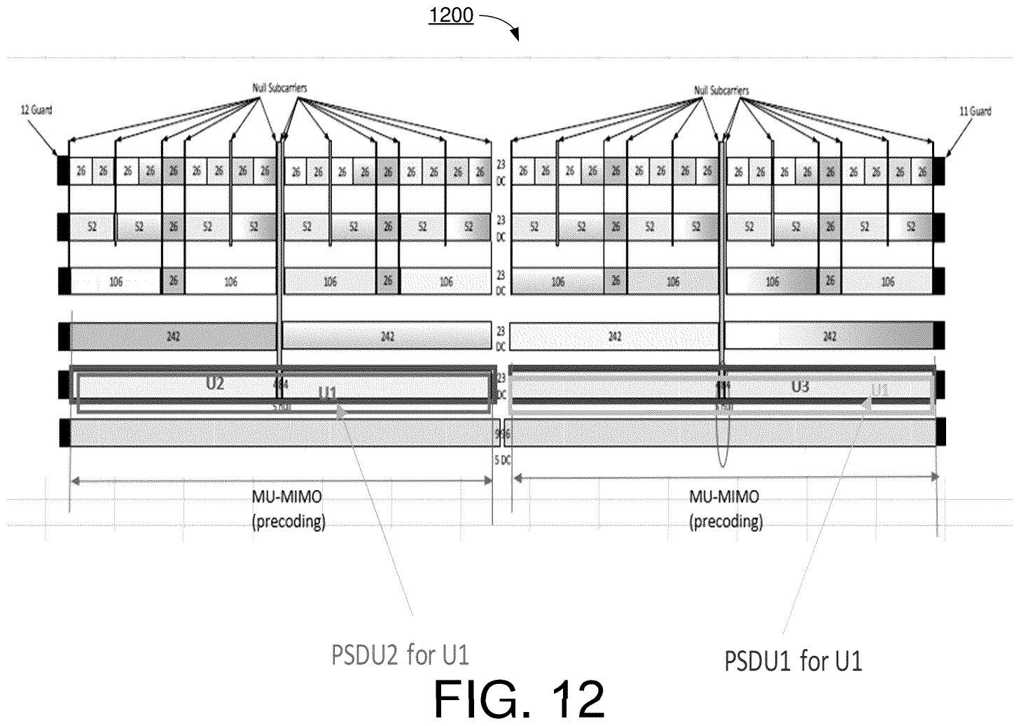

FIG. 12 illustrates an example scenario 1200 under Proposal-7. In the example shown in FIG. 12, with 80 MHz, a first user (U1) may operate (e.g., communicate such as transmit and/or receive) with a first PSDU (PSDU1) on a first RU484 and with a second PSDU (PSDU2) on a second RU484, a second user (U2) may operate on the first RU484, and a third user (U3) may operate on the second RU484.

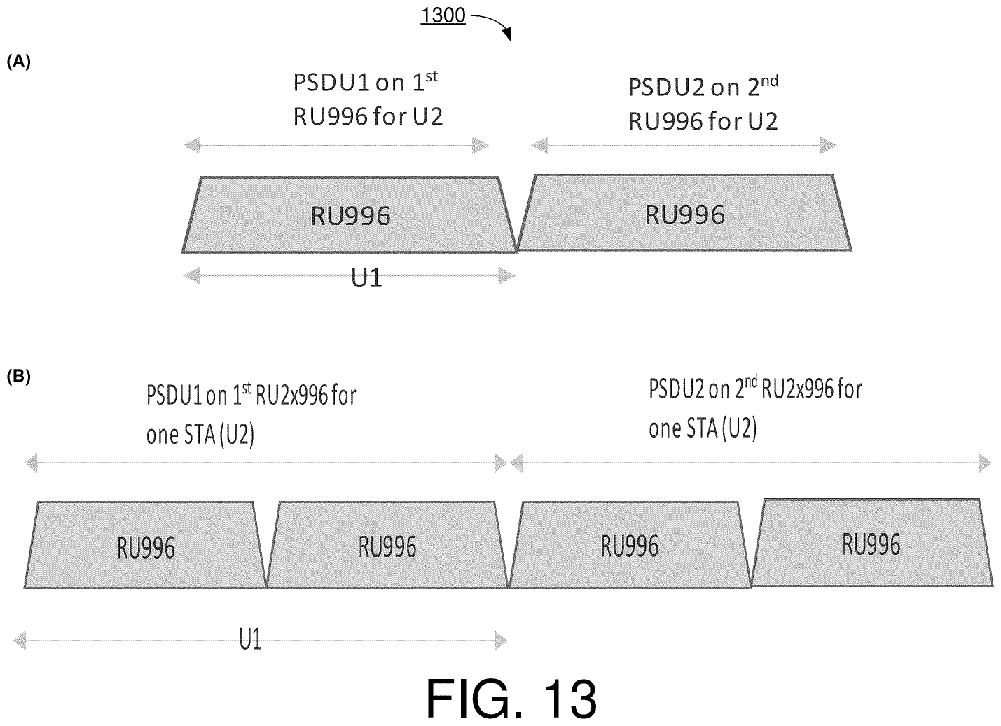

FIG. 13 illustrates an example scenario 1300 under Proposal-7. In the example shown in part (A) of FIG. 13, with 160 MHz, unequal MCS or EQUM may be applied on PSDU1 and PSDU2 for U2. Alternatively, unequal number of spatial streams may be applied on PSDU1 and PSDU2 for U2. In the example shown in part (B) of FIG. 13, with 320 MHz, unequal MCS or UEQM may be applied on PSDU1 and PSDU2 for U2. Alternatively, unequal number of spatial streams may be applied on PSDU1 and PSDU2 for U2.

### Illustrative Implementations

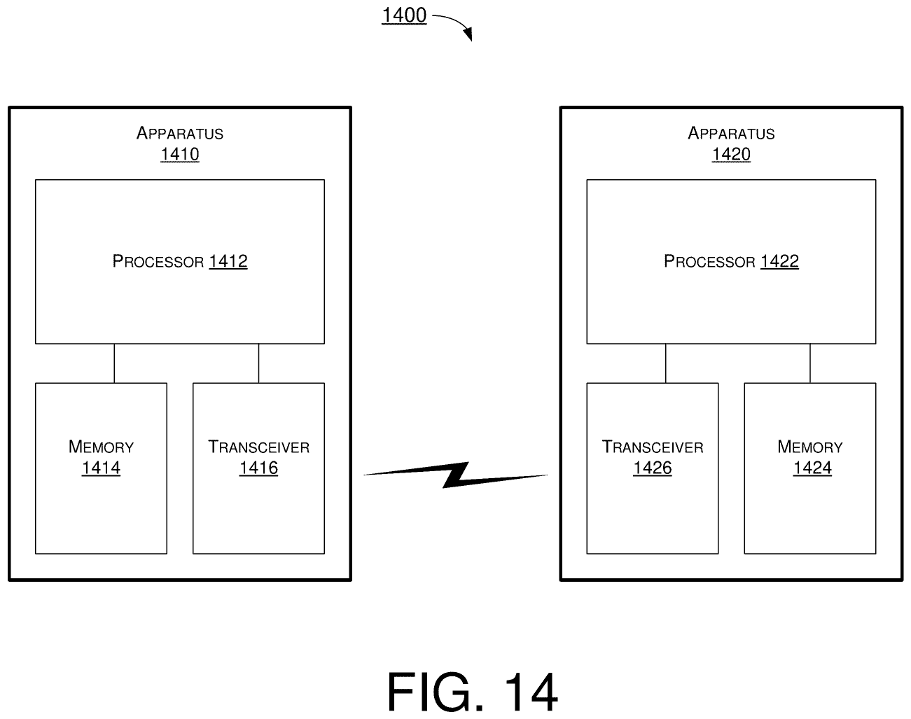

FIG. 14 illustrates an example system 1400 having at least an example apparatus 1410 and an example apparatus 1420 in accordance with an implementation of the present disclosure. Each of apparatus 1410 and apparatus 1420 may perform various functions to implement schemes, techniques, processes and methods described herein pertaining to MU-MIMO transmission with mixed bandwidths and UEQM in wireless communications, including the various schemes described above with respect to various proposed designs, concepts, schemes, systems and methods described above as well as processes described below. For instance, apparatus 1410 may be implemented in STA 110 and apparatus 1420 may be implemented in STA 120, or vice versa.

Each of apparatus 1410 and apparatus 1420 may be a part of an electronic apparatus, which may be a non-AP STA or an AP STA, such as a portable or mobile apparatus, a wearable apparatus, a wireless communication apparatus or a computing apparatus. When implemented in a STA, each of apparatus 1410 and apparatus 1420 may be implemented in a smartphone, a smartwatch, a personal digital assistant, a digital camera, or a computing equipment such as a tablet computer, a laptop computer or a notebook computer. Each of apparatus 1410 and apparatus 1420 may also be a part of a machine type apparatus, which may be an IoT apparatus such as an immobile or a stationary apparatus, a home apparatus, a wire communication apparatus or a computing apparatus. For instance, each of apparatus 1410 and apparatus 1420 may be implemented in a smart thermostat, a smart fridge, a smart door lock, a wireless speaker or a home control center. When implemented in or as a network apparatus, apparatus 1410 and/or apparatus 1420 may be implemented in a network node, such as an AP in a WLAN.

In some implementations, each of apparatus 1410 and apparatus 1420 may be implemented in the form of one or more integrated-circuit (IC) chips such as, for example and without limitation, one or more single-core processors, one or more multi-core processors, one or more reduced-instruction set computing (RISC) processors, or one or more complex-instruction-set-computing (CISC) processors. In the various schemes described above, each of apparatus 1410 and apparatus 1420 may be implemented in or as a STA or an AP. Each of apparatus 1410 and apparatus 1420 may include at least some of those components shown in FIG. 14 such as a processor 1412 and a processor 1422, respectively, for example. Each of apparatus 1410 and apparatus 1420 may further include one or more other components not pertinent to the proposed scheme of the present disclosure (e.g., internal power supply, display device and/or user interface device), and, thus, such component(s) of apparatus 1410 and apparatus 1420 are neither shown in FIG. 14 nor described below in the interest of simplicity and brevity.

In one aspect, each of processor 1412 and processor 1422 may be implemented in the form of one or more single-core processors, one or more multi-core processors, one or more RISC processors or one or more CISC processors. That is, even though a singular term “a processor” is used herein to refer to processor 1412 and processor 1422, each of processor 1412 and processor 1422 may include multiple processors in some implementations and a single processor in other implementations in accordance with the present disclosure. In another aspect, each of processor 1412 and processor 1422 may be implemented in the form of hardware (and, optionally, firmware) with electronic components including, for example and without limitation, one or more transistors, one or more diodes, one or more capacitors, one or more resistors, one or more inductors, one or more memristors and/or one or more varactors that are configured and arranged to achieve specific purposes in accordance with the present disclosure. In other words, in at least some implementations, each of processor 1412 and processor 1422 is a special-purpose machine specifically designed, arranged and configured to perform specific tasks including those pertaining to MU-MIMO transmission with mixed bandwidths and UEQM in wireless communications in accordance with various implementations of the present disclosure.

In some implementations, apparatus 1410 may also include a transceiver 1416 coupled to processor 1412. Transceiver 1416 may include a transmitter capable of wirelessly transmitting and a receiver capable of wirelessly receiving data. In some implementations, apparatus 1420 may also include a transceiver 1426 coupled to processor 1422. Transceiver 1426 may include a transmitter capable of wirelessly transmitting and a receiver capable of wirelessly receiving data. It is noteworthy that, although transceiver 1416 and transceiver 1426 are illustrated as being external to and separate from processor 1412 and processor 1422, respectively, in some implementations, transceiver 1416 may be an integral part of processor 1412 as a system on chip (SoC), and transceiver 1426 may be an integral part of processor 1422 as a SoC.

In some implementations, apparatus 1410 may further include a memory 1414 coupled to processor 1412 and capable of being accessed by processor 1412 and storing data therein. In some implementations, apparatus 1420 may further include a memory 1424 coupled to processor 1422 and capable of being accessed by processor 1422 and storing data therein. Each of memory 1414 and memory 1424 may include a type of random-access memory (RAM) such as dynamic RAM (DRAM), static RAM (SRAM), thyristor RAM (T-RAM) and/or zero-capacitor RAM (Z-RAM). Alternatively, or additionally, each of memory 1414 and memory 1424 may include a type of read-only memory (ROM) such as mask ROM, programmable ROM (PROM), erasable programmable ROM (EPROM) and/or electrically erasable programmable ROM (EEPROM). Alternatively, or additionally, each of memory 1414 and memory 1424 may include a type of non-volatile random-access memory (NVRAM) such as flash memory, solid-state memory, ferroelectric RAM (FeRAM), magnetoresistive RAM (MRAM) and/or phase-change memory.

Each of apparatus 1410 and apparatus 1420 may be a communication entity capable of communicating with each other using various proposed schemes in accordance with the present disclosure. For illustrative purposes and without limitation, a description of capabilities of apparatus 1410, as STA 110, and apparatus 1420, as STA 120, is provided below in the context of example processes 1500 and 1600. It is noteworthy that, although a detailed description of capabilities, functionalities and/or technical features of either of apparatus 1410 and apparatus 1420 is provided below, the same may be applied to the other of apparatus 1410 and apparatus 1420 although a detailed description thereof is not provided solely in the interest of brevity. It is also noteworthy that, although the example implementations described below are provided in the context of WLAN, the same may be implemented in other types of networks.

### Illustrative Processes

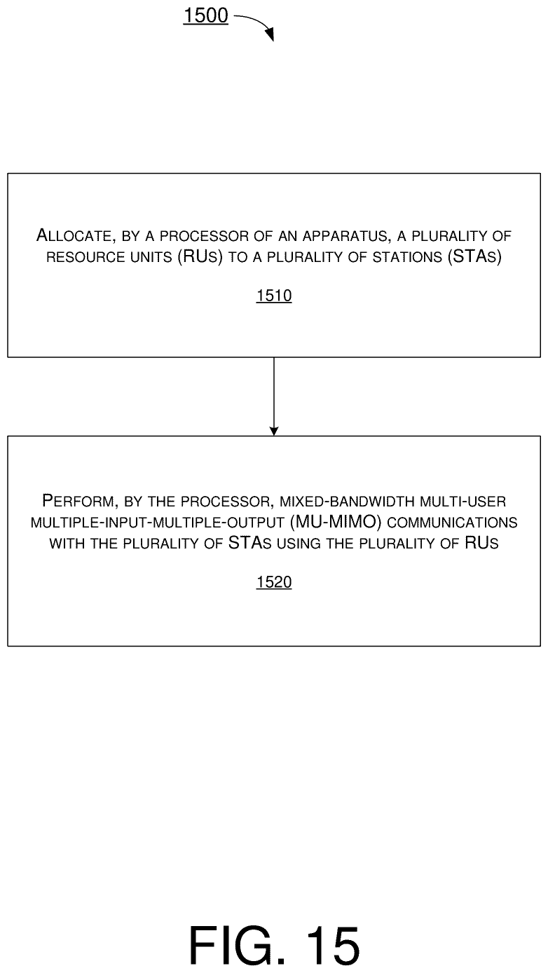

FIG. 15 illustrates an example process 1500 in accordance with an implementation of the present disclosure. Process 1500 may represent an aspect of implementing various proposed designs, concepts, schemes, systems and methods described above. More specifically, process 1500 may represent an aspect of the proposed concepts and schemes pertaining to MU-MIMO transmission with mixed bandwidths and UEQM in wireless communications in accordance with the present disclosure. Process 1500 may include one or more operations, actions, or functions as illustrated by one or more of blocks 1510 and 1520. Although illustrated as discrete blocks, various blocks of process 1500 may be divided into additional blocks, combined into fewer blocks, or eliminated, depending on the desired implementation. Moreover, the blocks/sub-blocks of process 1500 may be executed in the order shown in FIG. 15 or, alternatively, in a different order. Furthermore, one or more of the blocks/sub-blocks of process 1500 may be executed repeatedly or iteratively. Process 1500 may be implemented by or in apparatus 1410 and apparatus 1420 as well as any variations thereof. Solely for illustrative purposes and without limiting the scope, process 1500 is described below in the context of apparatus 1410 implemented in or as STA 110 functioning as a non-AP STA and apparatus 1420 implemented in or as STA 120 functioning as an AP STA of a wireless network such as a WLAN in network environment 100 in accordance with one or more of IEEE 802.11 standards. Process 1500 may begin at block 1510.

At 1510, process 1500 may involve processor 1422 of apparatus 1420 allocating, via transceiver 1426, a plurality of RUs to a plurality of STAs (e.g., including apparatus 1410 as STA 110). Process 1500 may proceed from 1510 to 1520.

At 1520, process 1500 may involve processor 1422 performing, via transceiver 1426, mixed-bandwidth MU-MIMO communications with the plurality of STAs using the plurality of RUs.

In some implementations (Proposal-0), in performing the mixed-bandwidth MU-MIMO communications, process 1500 may involve processor 1422 performing the mixed-bandwidth MU-MIMO communications without limitations.

In some implementations (Proposal-1), in performing the mixed-bandwidth MU-MIMO communications, process 1500 may involve processor 1422 performing the mixed-bandwidth MU-MIMO communications with alignment of RU boundaries.

In some implementations (Proposal-2), in performing the mixed-bandwidth MU-MIMO communications, process 1500 may involve processor 1422 performing the mixed-bandwidth MU-MIMO communications with each of the plurality of RUs being a RU242 or larger.

In some implementations (Proposal-3), in performing the mixed-bandwidth MU-MIMO communications, process 1500 may involve processor 1422 performing the mixed-bandwidth MU-MIMO communications across different 80 MHz frequency segments or frequency subblocks with each of the plurality of RUs being a RU996 and boundary aligned.

In some implementations (Proposal-4), in performing the mixed-bandwidth MU-MIMO communications, process 1500 may involve processor 1422 performing the mixed-bandwidth MU-MIMO communications across different 80 MHz frequency segments or frequency subblocks with each of the plurality of RUs being a RU484 or larger.

In some implementations (Proposal-5), in performing the mixed-bandwidth MU-MIMO communications, process 1500 may involve processor 1422 performing the mixed-bandwidth MU-MIMO communications with unequal modulations with respect to at least one STA of the plurality of STAs such that a first modulation is applied on a first RU allocated to the at least one STA and a second modulation different from the first modulation is applied on a second RU allocated to the at least one STA.

In some implementations (Proposal-6), in performing the mixed-bandwidth MU-MIMO communications, process 1500 may involve processor 1422 performing the mixed-bandwidth MU-MIMO communications with unequal numbers of spatial streams with respect to at least one STA of the plurality of STAs such that a first number of spatial streams (Nₛₛ₁) is assigned to a first RU allocated to the at least one STA and a second number of spatial streams (Nₛₛ₂) different from the Nₛₛ₁ is assigned to a second RU allocated to the at least one STA. In some implementations (Proposal-0), in performing the mixed-bandwidth MU-MIMO communications, process 1500 may further involve processor 1422 performing the mixed-bandwidth MU-MIMO communications with unequal modulations with respect to the at least one STA such that a first modulation is applied on the first RU and a second modulation different from the first modulation is applied on the second RU.

In some implementations (Proposal-7), in performing the mixed-bandwidth MU-MIMO communications, process 1500 may involve processor 1422 performing the mixed-bandwidth MU-MIMO communications with at least one STA of the plurality of STAs communicating using multiple PSDUs on multiple RUs of the plurality of RUs.

FIG. 16 illustrates an example process 1600 in accordance with an implementation of the present disclosure. Process 1600 may represent an aspect of implementing various proposed designs, concepts, schemes, systems and methods described above. More specifically, process 1600 may represent an aspect of the proposed concepts and schemes pertaining to MU-MIMO transmission with mixed bandwidths and UEQM in wireless communications in accordance with the present disclosure. Process 1600 may include one or more operations, actions, or functions as illustrated by one or more of blocks 1610 and 1620. Although illustrated as discrete blocks, various blocks of process 1600 may be divided into additional blocks, combined into fewer blocks, or eliminated, depending on the desired implementation. Moreover, the blocks/sub-blocks of process 1600 may be executed in the order shown in FIG. 16 or, alternatively, in a different order. Furthermore, one or more of the blocks/sub-blocks of process 1600 may be executed repeatedly or iteratively. Process 1600 may be implemented by or in apparatus 1410 and apparatus 1420 as well as any variations thereof. Solely for illustrative purposes and without limiting the scope, process 1600 is described below in the context of apparatus 1410 implemented in or as STA 110 functioning as a non-AP STA and apparatus 1420 implemented in or as STA 120 functioning as an AP STA of a wireless network such as a WLAN in network environment 100 in accordance with one or more of IEEE 802.11 standards. Process 1600 may begin at block 1610.

At 1610, process 1600 may involve processor 1412 of apparatus 1410 generating one or more RUs (which may be allocated to apparatus 1410 by apparatus 1420 as STA 120). Process 1600 may proceed from 1610 to 1620.

At 1620, process 1600 may involve processor 1412 performing, via transceiver 1416, mixed-bandwidth MU-MIMO communications with the one or more RUs.

In some implementations (Proposal-3), in performing the mixed-bandwidth MU-MIMO communications, process 1600 may involve processor 1412 performing the mixed-bandwidth MU-MIMO communications across different 80 MHz frequency segments or frequency subblocks with each of the one or more RUs being a RU996 and boundary aligned.

In some implementations (Proposal-5), in performing the mixed-bandwidth MU-MIMO communications, process 1600 may involve processor 1412 performing the mixed-bandwidth MU-MIMO communications with unequal modulations such that a first modulation is applied on a first RU of the one or more RUs and a second modulation different from the first modulation is applied on a second RU of the one or more RUs.

In some implementations (Proposal-6), in performing the mixed-bandwidth MU-MIMO communications, process 1600 may involve processor 1412 performing the mixed-bandwidth MU-MIMO communications with unequal numbers of spatial streams such that a first number of spatial streams (Nₛₛ₁) is assigned to a first RU of the one or more RUs and a second number of spatial streams (Nₛₛ₂) different from the Nₛₛ₁ is assigned to a second RU of the one or more RUs. In some implementations, in performing the mixed-bandwidth MU-MIMO communications, process 1600 may further involve processor 1412 performing the mixed-bandwidth MU-MIMO communications with unequal modulations such that a first modulation is applied on the first RU and a second modulation different from the first modulation is applied on the second RU.

### ADDITIONAL NOTES

The herein-described subject matter sometimes illustrates different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled”, to each other to achieve the desired functionality, and any two components capable of being so associated can also be viewed as being “operably couplable”, to each other to achieve the desired functionality. Specific examples of operably couplable include but are not limited to physically mateable and/or physically interacting components and/or wirelessly interactable and/or wirelessly interacting components and/or logically interacting and/or logically interactable components.

Further, with respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

Moreover, it will be understood by those skilled in the art that, in general, terms used herein, and especially in the appended claims, e.g., bodies of the appended claims, are generally intended as “open” terms, e.g., the term “including” should be interpreted as “including but not limited to,” the term “having” should be interpreted as “having at least,” the term “includes” should be interpreted as “includes but is not limited to,” etc. It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to implementations containing only one such recitation, even when the same claim includes the introductory phrases “one or more” or “at least one” and indefinite articles such as “a” or “an,” e.g., “a” and/or “an” should be interpreted to mean “at least one” or “one or more;” the same holds true for the use of definite articles used to introduce claim recitations. In addition, even if a specific number of an introduced claim recitation is explicitly recited, those skilled in the art will recognize that such recitation should be interpreted to mean at least the recited number, e.g., the bare recitation of “two recitations,” without other modifiers, means at least two recitations, or two or more recitations. Furthermore, in those instances where a convention analogous to “at least one of A, B, and C, etc.” is used, in general such a construction is intended in the sense one having skill in the art would understand the convention, e.g., “a system having at least one of A, B, and C” would include but not be limited to systems that have A alone, B alone, C alone, A and B together, A and C together, B and C together, and/or A, B, and C together, etc. In those instances where a convention analogous to “at least one of A, B, or C, etc.” is used, in general such a construction is intended in the sense one having skill in the art would understand the convention, e.g., “a system having at least one of A, B, or C” would include but not be limited to systems that have A alone, B alone, C alone, A and B together, A and C together, B and C together, and/or A, B, and C together, etc. It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

From the foregoing, it will be appreciated that various implementations of the present disclosure have been described herein for purposes of illustration, and that various modifications may be made without departing from the scope and spirit of the present disclosure. Accordingly, the various implementations disclosed herein are not intended to be limiting, with the true scope and spirit being indicated by the following claims.

What is claimed is:

1. A method, comprising:
allocating, by a processor of an apparatus, a plurality of resource units (RUs) to a plurality of stations (STAs); and
performing, by the processor, mixed-bandwidth multi-user multiple-input-multiple-output (MU-MIMO) communications with the plurality of STAs using the plurality of RUs.

2. The method of claim 1, wherein the performing of the mixed-bandwidth MU-MIMO communications comprises performing the mixed-bandwidth MU-MIMO communications without limitations.

3. The method of claim 1, wherein the performing of the mixed-bandwidth MU-MIMO communications comprises performing the mixed-bandwidth MU-MIMO communications with alignment of RU boundaries.

4. The method of claim 1, wherein the performing of the mixed-bandwidth MU-MIMO communications comprises performing the mixed-bandwidth MU-MIMO communications with each of the plurality of RUs being a 242-tone RU (RU242) or larger.

5. The method of claim 1, wherein the performing of the mixed-bandwidth MU-MIMO communications comprises performing the mixed-bandwidth MU-MIMO communications across different 80 MHz frequency segments or frequency subblocks with each of the plurality of RUs being a 996-tone RU (RU996) and boundary aligned.

6. The method of claim 1, wherein the performing of the mixed-bandwidth MU-MIMO communications comprises performing the mixed-bandwidth MU-MIMO communications across different 80 MHz frequency segments or frequency subblocks with each of the plurality of RUs being a 484-tone RU (RU484) or larger.

7. The method of claim 1, wherein the performing of the mixed-bandwidth MU-MIMO communications comprises performing the mixed-bandwidth MU-MIMO communications with unequal modulations with respect to at least one STA of the plurality of STAs such that a first modulation is applied on a first RU allocated to the at least one STA and a second modulation different from the first modulation is applied on a second RU allocated to the at least one STA.

8. The method of claim 1, wherein the performing of the mixed-bandwidth MU-MIMO communications comprises performing the mixed-bandwidth MU-MIMO communications with unequal numbers of spatial streams with respect to at least one STA of the plurality of STAs such that a first number of spatial streams (Nₛₛ₁) is assigned to a first RU allocated to the at least one STA and a second number of spatial streams (Nₛₛ₂) different from the Nₛₛ₁ is assigned to a second RU allocated to the at least one STA.

9. The method of claim 8, wherein the performing of the mixed-bandwidth MU-MIMO communications further comprises performing the mixed-bandwidth MU-MIMO communications with unequal modulations with respect to the at least one STA such that a first modulation is applied on the first RU and a second modulation different from the first modulation is applied on the second RU.

10. The method of claim 1, wherein the performing of the mixed-bandwidth MU-MIMO communications comprises performing the mixed-bandwidth MU-MIMO communications with at least one STA of the plurality of STAs communicating using multiple physical-layer service data units (PSDUs) on multiple RUs of the plurality of RUs.

11. A method, comprising:
generating, by a processor of an apparatus, one or more resource units (RUs); and
performing, by the processor, mixed-bandwidth multi-user multiple-input-multiple-output (MU-MIMO) communications with the one or more RUs.

12. The method of claim 11, wherein the performing of the mixed-bandwidth MU-MIMO communications comprises performing the mixed-bandwidth MU-MIMO communications across different 80 MHz frequency segments or frequency subblocks with each of the one or more RUs being a 996-tone RU (RU996) and boundary aligned.

13. The method of claim 11, wherein the performing of the mixed-bandwidth MU-MIMO communications comprises performing the mixed-bandwidth MU-MIMO communications with unequal modulations such that a first modulation is applied on a first RU of the one or more RUs and a second modulation different from the first modulation is applied on a second RU of the one or more RUs.

14. The method of claim 11, wherein the performing of the mixed-bandwidth MU-MIMO communications comprises performing the mixed-bandwidth MU-MIMO communications with unequal numbers of spatial streams such that a first number of spatial streams (Nₛₛ₁) is assigned to a first RU of the one or more RUs and a second number of spatial streams (Nₛₛ₂) different from the Nₛₛ₁ is assigned to a second RU of the one or more RUs.

15. The method of claim 14, wherein the performing of the mixed-bandwidth MU-MIMO communications further comprises performing the mixed-bandwidth MU-MIMO communications with unequal modulations such that a first modulation is applied on the first RU and a second modulation different from the first modulation is applied on the second RU.

16. An apparatus, comprising:
a transceiver configured to communicate wirelessly; and
a processor coupled to the transceiver and configured to perform operations comprising:
allocating, via the transceiver, a plurality of resource units (RUs) to a plurality of stations (STAs); and
performing, via the transceiver, mixed-bandwidth multi-user multiple-input-multiple-output (MU-MIMO) communications with the plurality of STAs using the plurality of RUs.

17. The apparatus of claim 16, wherein the performing of the mixed-bandwidth MU-MIMO communications comprises performing the mixed-bandwidth MU-MIMO communications across different 80 MHz frequency segments or frequency subblocks with each of the plurality of RUs being a 996-tone RU (RU996) and boundary aligned.

18. The apparatus of claim 16, wherein the performing of the mixed-bandwidth MU-MIMO communications comprises performing the mixed-bandwidth MU-MIMO communications with unequal modulations with respect to at least one STA of the plurality of STAs such that a first modulation is applied on a first RU allocated to the at least one STA and a second modulation different from the first modulation is applied on a second RU allocated to the at least one STA.

19. The apparatus of claim 16, wherein the performing of the mixed-bandwidth MU-MIMO communications comprises performing the mixed-bandwidth MU-MIMO communications with unequal numbers of spatial streams with respect to at least one STA of the plurality of STAs such that a first number of spatial streams (Nₛₛ₁) is assigned to a first RU allocated to the at least one STA and a second number of spatial streams (Nₛₛ₂) different from the Nₛₛ₁ is assigned to a second RU allocated to the at least one STA.

20. The apparatus of claim 19, wherein the performing of the mixed-bandwidth MU-MIMO communications further comprises performing the mixed-bandwidth MU-MIMO communications with unequal modulations with respect to the at least one STA such that a first modulation is applied on the first RU and a second modulation different from the first modulation is applied on the second RU.
